(19) United States
(12) Patent Application Publication
(10) Pub. No.: US 2025/0225363 A1
(43) Pub. Date: Jul. 10, 2025

(54) Be Anyone and Anything

(71) Applicant: Foretell Studios, New York, NY (US)

(72) Inventors: Lyron Live Bentovim, North Woodstock, NH (US); Jacob Maymar, South Orange, NJ (US); David John Smith, Morristown, NJ (US)

(73) Assignee: Foretell Studios, New York, NY (US)

(21) Appl. No.: 18/407,171

(22) Filed: Jan. 8, 2024

(51) Int. Cl. G06N 3/006

(52) U.S. Cl. CPC G06N 3/006

(57) ABSTRACT

The present invention pertains to the field of Digital and Virtual Reality, addressing the deficiency in current technology for creating authentic digital replicas that faithfully capture user behaviors, emotions, metaphysical essence, and physical attributes of objects and environments. Existing technologies fall short in providing a comprehensive solution. This invention fills the void by offering a platform to generate precise digital replicas derived from data collected through wearable and external sensors. Users can then license or rent these replicas for diverse applications, such as connecting with deceased loved ones or evaluating products and experiences. Moreover, the invention facilitates the fusion of user essence with the physical characteristics of places and objects, enabling the creation of anthropomorphized and anomalous entities.

### CROSS-REFERENCE TO RELATED APPLICATIONS

Reference is made to the following patents and patent applications, owned by the assignee, the disclosures of which are hereby incorporated by reference:

This application claims benefit of priority U.S. Provisional Patent Application Ser. No. U.S. 202263432368-P filed Dec. 14, 2022 and titled “Be Anyone and Anything”; the entire content and substance of which is hereby incorporated into this application in total by reference.

### PRIOR ART

There are a number of examples in the field of technology for Digital and Virtual Reality. One approach is known as digital avatars. digital avatars are three-dimensional (3d) digital characters that represent the user in a virtual world or in online platforms, however, these avatars only represent the physical appearance of the user and lack the capability to replicate the user's behaviors, emotions, and metaphysical essence.

One approach is known as virtual reality experiences. virtual reality (vr) technology allows users to immerse themselves in a digital environment, however, the experiences are limited to pre-designed scenarios and do not incorporate the user's unique behaviors and emotions.

One approach is known as augmented reality. augmented reality (ar) overlays digital information onto the real world, however, it does not provide a platform for users to create and license their digital replicas.

The following publications are believed to represent the current state of the art:
U.S. Patent Publication No. US20210106236-A1 published on Apr. 15, 2021 titled HEARING AND MONITORING SYSTEM by TRAN BAO; Tran, Bao
U.S. Patent Publication No. US20220023742-A1 published on Jan. 27, 2022 titled BLOCKCHAIN by TRAN BAO; TRAN HA; Tran, Bao; Tran, Ha
U.S. Patent Publication No. US20210256070-A1 published on Aug. 19, 2021 titled NON-FUNGIBLE TOKEN (NFT) by TRAN BAO; TRAN HA; Tran, Bao; Tran, Ha
U.S. Patent Publication No. US20210286868-A1 published on Sep. 16, 2021 titled Method For Providing An Authenticated Digital Identity by KRAGH JAMES F; Kragh, James F.
U.S. Patent Publication No. US20200387896-A1 published on Dec. 10, 2020 titled Blockchain by TRAN BAO; TRAN HA; Tran, Bao; Tran, Ha.

### BACKGROUND OF THE INVENTION

The present invention relates generally to Digital and Virtual Reality.

### SUMMARY OF THE INVENTION

The present invention seeks to provide creating and using digital human behavior replicas.

in the field of Digital and Virtual Reality, the current technology lacks the capability to create a digital replica that truly represents user's behaviors, emotions, metaphysical essence, and physical attributes of places and things. This gap limits the potential virtual experiences and applications. When considering prior arts in that field, there is still a gap providing said solution. The gap the present invention seeks to provide relates to the current world lacks a platform that allows users to create, own, and license their digital replicas that accurately represent their behaviors, emotions, and metaphysical essence. Also, there's no technology that combines user's essence with physical properties of places/things to create anthropomorphized and/or anomalous places or items.

There is thus provided in accordance with a preferred embodiment of the present invention The invention collects and processes data from wearable and external sensors to create a digital replica that accurately represents user's behaviors, emotions, metaphysical essence, and physical attributes of places and things. This digital replica can be licensed or rented based on the user's consent and can be used in various applications such as reconnecting with a deceased loved one or testing a product or experience.

The invention also allows the combination of user's essence with physical properties of places/things to create anthropomorphized and/or anomalous places or items.

### BRIEF DESCRIPTION OF DRAWINGS

The present invention will be understood and appreciated more fully from the following detailed description taken in conjunction with the drawing in which:

FIG. 1 is a simplified illustration of process for creating and using digital human behavior replicas. constructed and operative in accordance with a preferred embodiment of the invention;

FIG. 1 is a simplified illustration of process for creating and using digital human behavior replicas. constructed and operative in accordance with a preferred embodiment of the invention;

FIG. 2 is a simplified block diagram illustration of another aspect of the use of the system of FIG. 1 for Online Gaming

FIG. 4 is a simplified block diagram illustration of another aspect of the use of the system of FIG. 1 for Healthcare

FIG. 5 is a simplified block diagram illustration of another aspect of the use of the system of FIG. 1 for Security and Surveillance.

### DETAILED DESCRIPTION OF THE INVENTION

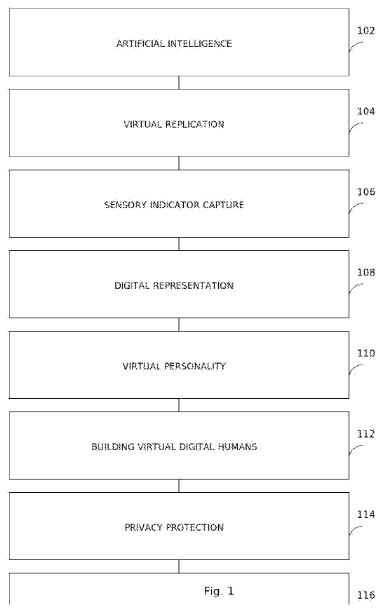

Reference is now made to FIG. 1, which is a simplified block diagram illustration of process for creating and using digital human behavior replicas. As shown in FIG. 1, the process includes the behavior patterns captured in step ((0)) are used to create unique profiles, which are then embodied in a virtual environment in step The unique profiles are embodied in a virtual environment, powered by artificial intelligence that bridges any cognitive gaps between a profile's standard and nonstandard behavior patterns. (102), and the artificial intelligence in step the unique profiles are embodied in a virtual environment, powered by artificial intelligence that bridges any cognitive gaps between a profile's standard and nonstandard behavior patterns. (102) bridges cognitive gaps, enabling the virtual replication process in step The process captures a real-person unique multi-sensory reactions and behaviors into a digital representation for virtual or augmented representation of a different actor. (104), and the virtual replication in step the process captures a real-person unique multi-sensory reactions and behaviors into a digital representation for virtual or augmented representation of a different actor. (104) utilizes the sensory indicators captured in step Wearable and stationary sensors capture distinguished unique combinations of user behaviors into a digital representation. (106), and the sensory indicators captured in step Wearable and stationary sensors capture distinguished unique combinations of user behaviors into a digital representation. (106) are used for the digital representation of physical characteristics in step Digital representation of physical characteristics of places and things to be applied in augmented or virtual environment. (108), and the digital representations from step Digital representation of physical characteristics of places and things to be applied in augmented or virtual environment. (108) are combined with human mannerisms to create a unique virtual personality in step A unique virtual personality is captured as a combination of digital representation of human mannerisms and behavior with a digital representation of place/thing. (110), and the virtual personality from step A unique virtual personality is captured as a combination of digital representation of human mannerisms and behavior with a digital representation of place/thing. (110) is used in the process of building virtual digital humans in step A system for building virtual digital humans as a combination of stored replicas of behavioral, psychological and emotional digital characteristics. (112), and the virtual digital humans created in step A system for building virtual digital humans as a combination of stored replicas of behavioral, psychological and emotional digital characteristics. (112) are secured and privacy protected in step Replicas are secured and privacy protected. (114), and the privacy protected replicas from step Replicas are secured and privacy protected. (114) are used to create a virtual facsimile in step Virtual facsimile replicates user's behaviors, emotions, and metaphysical essence using wearable and external sensor data. (116).

Reference is now made to FIG. 1, which is a simplified block diagram illustration of process for creating and using digital human behavior replicas. As shown in FIG. 1, the process includes the behavior patterns captured in step ((0)) are used to create unique profiles, which are then embodied in a virtual environment in step The unique profiles are embodied in a virtual environment, powered by artificial intelligence that bridges any cognitive gaps between a profile's standard and nonstandard behavior patterns. (102), and the artificial intelligence in step the unique profiles are embodied in a virtual environment, powered by artificial intelligence that bridges any cognitive gaps between a profile's standard and nonstandard behavior patterns. (102) bridges cognitive gaps, enabling the virtual replication process in step The process captures a real-person unique multi-sensory reactions and behaviors into a digital representation for virtual or augmented representation of a different actor. (104), and the virtual replication in step The process captures a real-person unique multi-sensory reactions and behaviors into a digital representation for virtual or augmented representation of a different actor. (104) utilizes the sensory indicators captured in step Wearable and stationary sensors capture distinguished unique combinations of user behaviors into a digital representation. (106), and the sensory indicators captured in step Wearable and stationary sensors capture distinguished unique combinations of user behaviors into a digital representation. (106) are used for the digital representation of physical characteristics in step Digital representation of physical characteristics of places and things to be applied in augmented or virtual environment. (108), and The digital representations from step Digital representation of physical characteristics of places and things to be applied in augmented or virtual environment. (108) are combined with human mannerisms to create a unique virtual personality in step A unique virtual personality is captured as a combination of digital representation of human mannerisms and behavior with a digital representation of place/thing. (110), and the virtual personality from step A unique virtual personality is captured as a combination of digital representation of human mannerisms and behavior with a digital representation of place/thing. (110) is used in the process of building virtual digital humans in step A system for building virtual digital humans as a combination of stored replicas of behavioral, psychological and emotional digital characteristics. (112), and the virtual digital humans created in step A system for building virtual digital humans as a combination of stored replicas of behavioral, psychological and emotional digital characteristics. (112) are secured and privacy protected in step Replicas are secured and privacy protected. (114), and the privacy protected replicas from step Replicas are secured and privacy protected. (114) are used to create a virtual facsimile in step Virtual facsimile replicates user's behaviors, emotions, and metaphysical essence using wearable and external sensor data. (116).

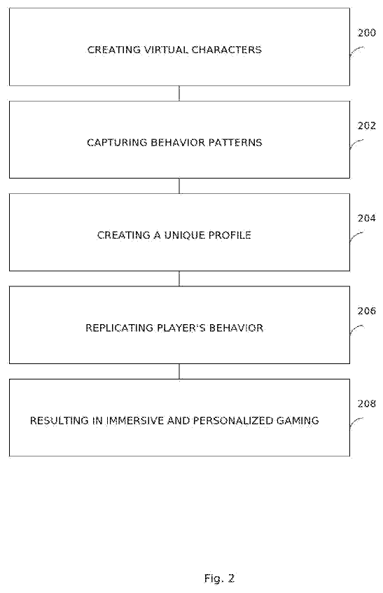

Reference is now made to FIG. 2, which is a simplified block diagram illustration of the system of FIG. 1. As shown in FIG. 2, This embodiment represents a Online Gaming.

Accordingly, The method can be used in online gaming to create virtual characters that mimic a player's behavior. The AI can capture the player's behavior patterns during gameplay and create a unique profile. This profile can be used to replicate the player's behavior in the game, resulting in a more immersive and personalized gaming experience.
The process of ‘Creating virtual characters’ A process that starts with online gaming where virtual characters that mimic a player's behavior are created. (200) leads to ‘Capturing behavior patterns’ In this step, the AI captures the player's behavior patterns during gameplay. (202), and ‘Capturing behavior patterns’ In this step, the AI captures the player's behavior patterns during gameplay. (202) leads to ‘Creating a unique profile’ The captured behavior patterns are then used to create a unique profile for the player. (204), and ‘Creating a unique profile’ The captured behavior patterns are then used to create a unique profile for the player. (204) is used in ‘Replicating player's behavior’ The unique profile is then used to replicate the player's behavior in the game. (206), and ‘Replicating player's behavior’ The unique profile is then used to replicate the player's behavior in the game. (206) results in ‘Resulting in immersive and personalized gaming’ The replication of the player's behavior results in a more immersive and personalized gaming experience. (208).

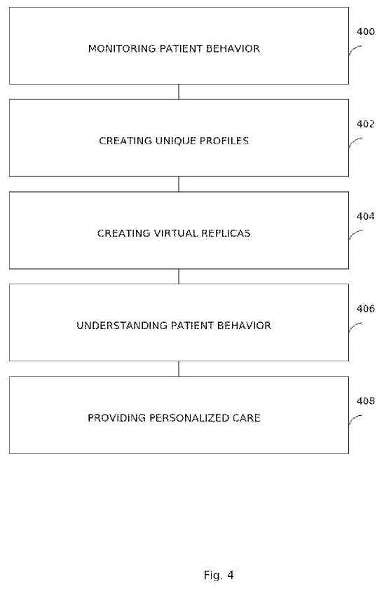

Reference is now made to FIG. 4, which is a simplified block diagram illustration of the system of FIG. 1. As shown in FIG. 4, This embodiment represents a Healthcare. Accordingly, The method can be used in healthcare to monitor patient behavior. It can capture the behavior patterns of patients and create unique profiles. These profiles can be used to create virtual replicas of the patients, allowing healthcare professionals to better understand the patient's behavior and provide more personalized care.

The monitoring of patient behavior A process that involves the surveillance of patient behavior to capture patterns. (400) leads to the creation of unique profiles This step involves the creation of unique profiles based on the captured behavior patterns of the patients. (402), and the unique profiles This step involves the creation of unique profiles based on the captured behavior patterns of the patients. (402) are used in creating virtual replicas in this step, virtual replicas of the patients are created using the unique profiles. (404), and the virtual replicas In this step, virtual replicas of the patients are created using the unique profiles. (404) aid healthcare professionals in understanding patient behavior This step involves healthcare professionals analyzing the virtual replicas to better understand the patient's behavior. (406) and Understanding patient behavior This step involves healthcare professionals analyzing the virtual replicas to better understand the patient's behavior. (406) results in providing more personalized care This final step involves the provision of more personalized care based on the understanding of the patient's behavior. (408).

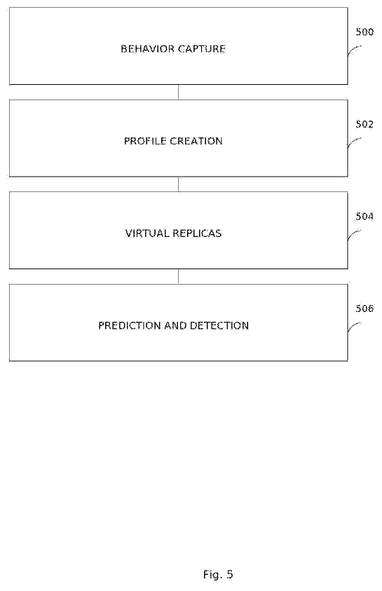

Reference is now made to FIG. 5, which is a simplified block diagram illustration of the system of FIG. 1. As shown in FIG. 5, This embodiment represents a Security and Surveillance. Accordingly, The method can be used in security and surveillance systems. It can capture the behavior patterns of individuals and create unique profiles. These profiles can be used to create virtual replicas of the individuals, allowing the surveillance system to predict and detect unusual behaviors more accurately.

The A process that starts with the capture of behavior patterns of individuals for security and surveillance systems. (500) step is connected to the the captured behavior patterns are then used to create unique profiles of the individuals. (502) step by using the captured behavior patterns to create unique profiles, and The the captured behavior patterns are then used to create unique profiles of the individuals. (502) step is connected to the These profiles are then used to create virtual replicas of the individuals. (504) step by using the unique profiles to create virtual replicas of the individuals, and The These profiles are then used to create virtual replicas of the individuals. (504) step is connected to the the virtual replicas allow the surveillance system to predict and detect unusual behaviors more accurately. (506) step by using the virtual replicas to predict and detect unusual behaviors more accurately.

It will be appreciated by persons skilled in the art that the present invention is not limited by what has been particularly shown and described hereinabove. Rather the scope of the present invention includes both combinations and sub-combinations of the various features described hereinabove as well as modifications thereof which would occur to persons skilled in the art upon reading the foregoing description and which are not in the prior art.

1. A method for creating and using digital human behavior replicas, the method comprising:
providing a process that captures behavior patterns in the context of dynamic and unexpected scenarios based on subjective and objective data. these patterns create unique profiles;
Artificial Intelligence;
Virtual Replication;
Sensory Indicator Capture;
Digital Representation;
Virtual Personality;
Building Virtual Digital Humans;
Privacy Protection;
Virtual Facsimile; Wherein
the behavior patterns captured in step said Behavior Capture are used to create unique profiles, which are then embodied in a virtual environment in step said Artificial Intelligence. the artificial intelligence in step said Artificial Intelligence bridges cognitive gaps, enabling the virtual replication process in step said Virtual Replication, the virtual replication in step said Virtual Replication utilizes the sensory indicators captured in step said Sensory Indicator Capture. the sensory indicators captured in step said Sensory Indicator Capture are used for the digital representation of physical characteristics in step said Digital Representation, the digital representations from step said Digital Representation are combined with human mannerisms to create a unique virtual personality in step said Virtual Personality. the virtual personality from step said Virtual Personality is used in the process of building virtual digital humans in step said Building Virtual Digital Humans. the virtual digital humans created in step said Building Virtual Digital Humans are secured and privacy protected in step said Privacy Protection. the privacy protected replicas from step said Privacy Protection are used to create a virtual facsimile in step said Virtual Facsimile.

2. The method according to claim 1, also comprising
a storage subsystem that stores said captured behavior patterns over time, and historical analysis sub-system; wherein
said historical analysis sub-system analyzes said storage subsystem for differences in the behavior and personality over time and applies said differences when creating said virtual facsimile.

3. A system comprising a non-transitory, tangible computer-readable medium in which computer program instructions are stored, which instructions, when read by a computer, cause the computer to creating and using digital human behavior replicas, the system comprising:
providing a process that captures behavior patterns in the context of dynamic and unexpected scenarios based on subjective and objective data. these patterns create unique profiles;
Artificial Intelligence;
Virtual Replication;
Sensory Indicator Capture;
Digital Representation;
Virtual Personality;
Building Virtual Digital Humans;
Privacy Protection;
Virtual Facsimile; Wherein
the behavior patterns captured in step said Behavior Capture are used to create unique profiles, which are then embodied in a virtual environment in step said Artificial Intelligence. the artificial intelligence in step said Artificial Intelligence bridges cognitive gaps, enabling the virtual replication process in step said Virtual Replication. the virtual replication in step said Virtual Replication utilizes the sensory indicators captured in step said Sensory Indicator Capture. the sensory indicators captured in step said Sensory Indicator Capture are used for the digital representation of physical characteristics in step said Digital Representation. the digital representations from step said Digital Representation are combined with human mannerisms to create a unique virtual personality in step said Virtual Personality. the virtual personality from step said Virtual Personality is used in the process of building virtual digital humans in step said Building Virtual Digital Humans. the virtual digital humans created in step said Building Virtual Digital Humans are secured and privacy protected in step said Privacy Protection. the privacy protected replicas from step said Privacy Protection are used to create a virtual facsimile in step said Virtual Facsimile.

4. The system according to claim 3, also comprising
a storage subsystem that stores said captured behavior patterns over time, and historical analysis sub-system; wherein
said historical analysis sub-system analyzes said storage subsystem for differences in the behavior and personality over time and applies said differences when creating said virtual facsimile.
